(19) United States
(12) Patent Application Publication
(10) Pub. No.: US 2023/0235911 A1
(43) Pub. Date: Jul. 27, 2023

(54) AIR CONDITIONER, TEMPERATURE PROTECTOR, AND METHOD FOR CONTROLLING COMMUNICATION OF AIR CONDITIONER

(71) Applicant: HISENSE AIR CONDITIONING CO., LTD., Qingdao (CN)

(72) Inventors: Zonge MU, Qingdao (CN); Jianbing CHEN, Qingdao (CN); Lintao WU, Qingdao (CN); Jianyong NIU, Qingdao (CN); Sicong LIU, Qingdao (CN)

(73) Assignee: HISENSE AIR CONDITIONING CO., LTD., Qingdao (CN)

(21) Appl. No.: 18/125,303

(22) Filed: Mar. 23, 2023

Related U.S. Application Data
(63) Continuation of application No. PCT/CN2021/081819, filed on Mar. 19, 2021.

(30) Foreign Application Priority Data
Sep. 25, 2020 (CN) 202011027015.9

(51) Int. Cl. F24F 11/63; G05B 19/042

(52) U.S. Cl. CPC F24F 11/63; G05B 19/042; G05B 2219/2614

(57) ABSTRACT

An air conditioner and a method for controlling air conditioner communication are disclosed. The air conditioner includes an indoor unit, an outdoor unit, and a temperature protector. The indoor unit includes an indoor control device and an indoor communication device. The outdoor unit includes an outdoor control device and an outdoor communication device. The temperature protector includes a temperature control device and a temperature control communication device. The temperature control device is configured to output a temperature control setting parameters. The temperature control communication device is coupled with the temperature control device. The temperature control communication device is configured to receive the temperature control setting parameters, generate a fifth high-frequency signal carrying the temperature control setting parameters based on the temperature control setting parameters, and load the fifth high-frequency signal to the power communication line, so as to output the temperature control setting parameters.

### CROSS-REFERENCE TO RELATED APPLICATIONS

This application is a continuation application of International Application No. PCT/CN2021/081819, filed on Mar. 19, 2021, which claims priority to Chinese Patent Application No. 202011027015.9, filed on Sep. 25, 2020, the entire contents of which are incorporated herein by reference in their entireties.

### TECHNICAL FIELD

The present disclosure relates to the technical field of air conditioning, and in particular, to an air conditioner, a temperature protector, and a method for controlling communication of an air conditioner.

### BACKGROUND

With an advancement of science and technology and an improvement of people's living standards, air conditioners have gradually entered people's lives and become a commonly product in people's work and life.

A split-type air conditioner includes an indoor unit and an outdoor unit. The indoor unit and the outdoor unit are installed indoors and outdoors respectively, and are connected through pipelines and wires.

### SUMMARY

In an aspect, an air conditioner is provided, and the air conditioner includes an indoor unit, an outdoor unit and a temperature protector. The indoor unit includes an indoor control device and an indoor communication device. The indoor control device is configured to output indoor unit parameters. The indoor communication device is coupled with the indoor control device. The indoor communication device is configured to receive the indoor unit parameters, generate a first high-frequency signal carrying the indoor unit parameters based on the indoor unit parameters, and load the first high-frequency signal to a power communication line, so as to output the indoor unit parameters. The outdoor unit is coupled with the indoor unit through the power communication line, and includes an outdoor control device and an outdoor communication device. The outdoor control device is configured to output outdoor unit parameters. The outdoor communication device is coupled with the outdoor control device. The outdoor communication device is configured to receive the outdoor unit parameters, generate a third high-frequency signal carrying the indoor unit parameters based on the outdoor unit parameters, and load the third high-frequency signal to the power communication line, so as to output the outdoor unit parameters. The temperature protector is coupled with the indoor unit and the outdoor unit through the power communication line. The temperature protector includes the temperature control device and the temperature control communication device. The temperature control device is configured to output temperature control setting parameters. The temperature control communication device is coupled with the temperature control device. The temperature control communication device is configured to receive the temperature control setting parameters, generate a fifth high-frequency signal carrying the temperature control setting parameters based on the temperature control setting parameters, and load the fifth high-frequency signal to the power communication line, so as to output the temperature control setting parameters.

In another aspect, a temperature protector is provided. The temperature protector includes a temperature control device and a temperature control communication device. The temperature control device is configured to output temperature control setting parameters. The temperature control communication device is coupled with the temperature control device. The temperature control communication device is configured to receive the temperature control setting parameters, generate a fifth high-frequency signal carrying the temperature control setting parameters based on the temperature control setting parameters, and load the fifth high-frequency signal to the power communication line, so as to output the temperature control setting parameters.

In yet another aspect, a method for controlling communication of an air conditioning is provided. And the method includes: receiving transmitter parameters output from a control device, wherein the transmitter parameters include at least one of indoor unit parameters, outdoor unit parameters, or temperature protector setting parameters; generating a high-frequency signal carrying the transmitter parameters based on the transmitter parameters; and loading the high-frequency signal carrying the transmitter parameters onto a power communication line to output the transmitter parameters.

### BRIEF DESCRIPTION OF THE DRAWINGS

In order to describe technical solutions in the present disclosure more clearly, the accompanying drawings to be used in embodiments of the present disclosure will be introduced briefly. However, the accompanying drawings to be described below are merely drawings of some embodiments of the present disclosure, and a person of ordinary skill in the art can obtain other drawings according to these drawings. In addition, the accompanying drawings in the following description may be regarded as schematic diagrams, but are not limitations on actual sizes of products, actual processes of methods and actual timings of signals to which the embodiments of the present disclosure relate.

FIG. 1 is a schematic diagram of an air conditioner, in accordance with some embodiments;

FIG. 2 is a diagram illustrating a communication manner of an air conditioner, in accordance with some embodiments;

FIG. 3 is a block diagram of an indoor unit, in accordance with some embodiments;

FIG. 4 is a block diagram of an outdoor unit, in accordance with some embodiments;

FIG. 5 is a block diagram of a temperature protector, in accordance with some embodiments;

FIG. 6 is a diagram illustrating a communication manner of an air conditioner, in accordance with some other embodiments;

FIG. 7 is a diagram illustrating a communication waveform conversion of an air conditioner, in accordance with some embodiments; and

FIG. 8 is a flow diagram of a method for controlling communication of an air conditioner, in accordance with some embodiments.

### DETAILED DESCRIPTION

The technical solutions in some embodiments of the present disclosure will be described clearly and completely with reference to the accompanying drawings. However, the described embodiments are merely some but not all of embodiments of the present disclosure. All other embodiments obtained on a basis of the embodiments of the present disclosure by a person of ordinary skill in the art shall be included in the protection scope of the present disclosure.

Unless the context requires otherwise, throughout the specification and the claims, the term “comprise” and other forms thereof such as the third-person singular form “comprises” and the present participle form “comprising” are construed as an open and inclusive meaning, i.e., “including, but not limited to.” In the description of the specification, the terms such as “one embodiment,” “some embodiments,” “exemplary embodiments,” “example,” “specific example,” or “some examples” are intended to indicate that specific features, structures, materials, or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics described herein may be included in any one or more embodiments or examples in any suitable manner.

Hereinafter, the terms such as “first” and “second” are only used for descriptive purposes and cannot be construed as indicating or implying the relative importance or implicitly indicating the number of indicated technical features. Therefore, a feature defined with “first” or “second” may explicitly or implicitly include one or more of these features. In the description of the embodiments of the present disclosure, the terms “a plurality of,” “the plurality of,” and “multiple” each mean two or more unless otherwise specified.

In the description of the embodiments, the expressions “coupled” and “connected” and derivatives thereof may be used. The term “connected” should be understood in a broad sense. For example, the term “connected” may represent a fixed connection, a detachable connection, or connected as an integrated body. Alternatively, the term “connected” may be directly “connected” or indirectly “connected” through an intermediate medium. The term “coupled” may be used in the description of some embodiments to indicate that two or more components are in direct physical or electrical contact with each other. The term “coupled” or “communicatively coupled,” however, may also mean that two or more components are not in direct contact with each other, but still cooperate or interact with each other. The embodiments disclosed herein are not necessarily limited to the content herein.

The use of “applicable to” or “configured to” herein indicates an open and inclusive expression, which does not exclude devices that are applicable to or configured to perform additional tasks or steps.

Some embodiments of the present disclosure provide an air conditioner.

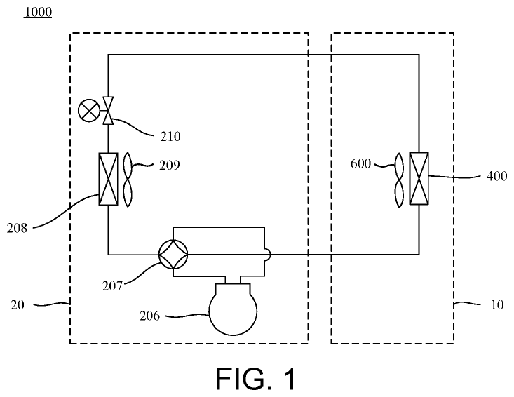

FIG. 1 is a schematic diagram of the air conditioner, in accordance with some embodiments. As shown in FIG. 1, the air conditioner 1000 includes an indoor unit 10 and an outdoor unit 20. The indoor unit 10 and the outdoor unit 20 are connected by pipelines, so as to transmit a refrigerant. The indoor unit 10 includes an indoor heat exchanger 400 and an indoor fan 600. The outdoor unit 20 includes a compressor 206, a four-way valve 207, an outdoor heat exchanger 208, an outdoor fan 209, and an expansion valve 210. The compressor 206, the outdoor heat exchanger 208, the expansion valve 210, and the indoor heat exchanger 400 are connected in sequence to constitute a refrigerant loop. The refrigerant circulates in the refrigerant loop and exchanges heat with air through the outdoor heat exchanger 208 and the indoor heat exchanger 400, so as to realize a cooling mode or a heating mode of the air conditioner 1000.

The compressor 206 is configured to compress a refrigerant, so that a low-pressure refrigerant is compressed to be a high-pressure refrigerant.

The outdoor heat exchanger 208 is configured to exchange heat between outdoor air and a refrigerant flowing in the outdoor heat exchanger 208. For example, the outdoor heat exchanger 208 operates as a condenser in the cooling mode of the air conditioner 1000, so that the refrigerant compressed by the compressor 206 is condensed by dissipating heat into the outdoor air through the outdoor heat exchanger 208. The outdoor heat exchanger 208 operates as an evaporator in the heating mode of the air conditioner 1000, so that the decompressed refrigerant is evaporated by absorbing heat from the outdoor air through the outdoor heat exchanger 208.

In some embodiments, the outdoor heat exchanger 208 includes heat exchange fins. Therefore, it may be possible to expand a contact area between the outdoor air and the refrigerant flowing in the outdoor heat exchanger 208, and in turn improve heat exchange efficiency between the outdoor air and the refrigerant.

The outdoor fan 209 is configured to induce the outdoor air into the outdoor unit 20 through an outdoor air inlet of the outdoor unit 20, and send the outdoor air, which has exchanged heat with the refrigerant flowing in the outdoor heat exchanger 208, out through an outdoor air outlet of the outdoor unit 20. The outdoor fan 209 provides power for the flow of the outdoor air.

The expansion valve 210 is connected between the outdoor heat exchanger 208 and the indoor heat exchanger 400. A pressure of a refrigerant flowing through the outdoor heat exchanger 208 and the indoor heat exchanger 400 is adjusted by adjusting a magnitude of an opening degree of the expansion valve 210, so that a flow rate of the refrigerant flowing through the outdoor heat exchanger 208 and the indoor heat exchanger 400 is adjusted. The flow rate and pressure of the refrigerant flowing through the outdoor heat exchanger 208 and the indoor heat exchanger 400 have influence on heat exchange performance of the outdoor heat exchanger 208 and heat exchange performance of the indoor heat exchanger 400. The expansion valve 210 may be an electronic valve. The opening degree of the expansion valve 210 is adjustable, so that the flow rate and pressure of the refrigerant flowing through the expansion valve 210.

The four-way valve 207 is connected in the refrigerant loop. The four-way valve 207 is configured to switch flowing directions of the refrigerant in the refrigerant loop, so that the operation mode of the air conditioner 1000 is switched between the cooling mode and the heating mode.

The indoor heat exchanger 400 is configured to exchange heat between indoor air and a refrigerant flowing in the indoor heat exchanger 400. For example, the indoor heat exchanger 400 operates as an evaporator in the cooling mode of the air conditioner 1000, so that the refrigerant, which has dissipated heat by the outdoor heat exchanger 208, is evaporated by absorbing heat from the indoor air through the indoor heat exchanger 400. The indoor heat exchanger 400 operates as a condenser in the heating mode of the air conditioner 1000, so that the refrigerant, which has absorbed heat through the outdoor heat exchanger 208, is condensed by dissipating heat into the indoor air through the indoor heat exchanger 400.

In some embodiments, the indoor heat exchanger 400 includes heat exchange fins. Therefore, it may be possible to expand a contact area between the indoor air and the refrigerant flowing in the indoor heat exchanger 400 and in turn improve heat exchange efficiency between the indoor air and the refrigerant.

The indoor fan 600 is configured to induce the indoor air into the indoor unit 10 through an indoor air inlet of the indoor unit 10 and send the indoor air, which has exchanged heat with the refrigerant flowing in the indoor heat exchanger 400, out through an indoor air outlet of the indoor unit 10. The indoor fan 600 provides power for the flow of the indoor air.

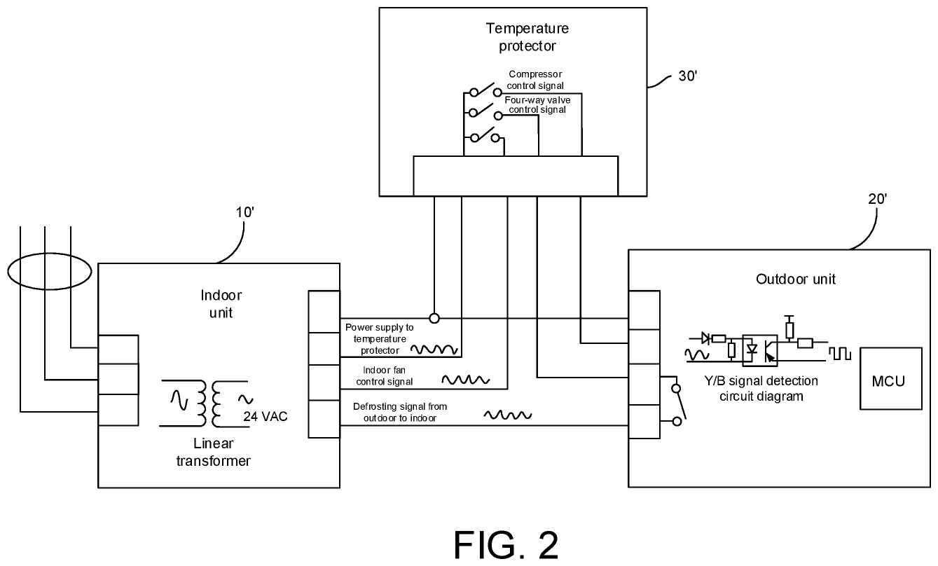

FIG. 2 is a diagram illustrating a communication manner of the air conditioner, in accordance with some embodiments. In general, as shown in FIG. 2, the air conditioner includes an indoor unit 10′, an outdoor unit 20′, and a temperature protector 30′. The indoor unit 10′, the outdoor unit 20′, and the temperature protector 30′ are coupled through a power communication line. The temperature protector 30′ is controlled by a user, so as to control the outdoor unit 20′ and indoor unit 10′ to operate. Signals output by the temperature protector 30′ to the outdoor unit 20′ and the indoor unit 10′ are alternating current (AC) signals. For example, the signals output by the temperature protector 30′ to the outdoor unit 20′ and the indoor unit 10′ are each a 24-volt AC (VAC) signal at power line frequency. However, an AC power communication manner may only implement opening and closing of the indoor unit 10′ or the outdoor unit 20′ through a one-way communication. That is, the indoor unit 10′, the outdoor unit 20′, and the temperature protector 30′ may each recognize only a high level portion and a low level portion in a square wave signal. For example, after the AC signals pass through a signal detection circuit of the outdoor unit 20′, the outdoor unit 20′ recognizes only a first-level signal (e.g., the high level portion in the square wave signal) and a second-level signal (e.g., the low level portion in the square wave signal). When the outdoor unit 20′ is a variable frequency unit, the outdoor unit 20′ receives a turn-on instruction or a turn-off instruction from the temperature protector 30′ by recognizing only the high level portion and the low level portion in the square wave signal. A controller of the outdoor unit 20′ (such as a microcontroller unit (MCU)) identifies only the square wave signal through circuit conversion; for example, the square wave signal includes a signal for starting or stopping the compressor 206, a signal for opening the four-way valve, and a defrosting signal output by the outdoor unit 20′ to the indoor unit 10′.

Therefore, the outdoor unit 20′ and the indoor unit 10′ cannot communicate with each other in real time by using the above AC communication manner, and each of the outdoor unit 20′ and the indoor unit 10′ cannot obtain specific operation parameters of a respective transmitter. For example, the outdoor unit 20′ may not obtain indoor unit parameters (such as an ambient temperature and an indoor coil temperature), and the indoor unit 10′ may not obtain outdoor unit parameters (such as a compressor frequency and an outdoor coil temperature). As a result, it is not conducive to adjusting the operating state of the air conditioner 1000 in real time, and the energy efficiency of the air conditioner 1000 is low.

In some embodiments of the present disclosure, the manner of communication between the indoor unit, the outdoor unit, and the temperature protector is improved to realize the transmission of the specific operating parameters, so that a control strategy of the air conditioner 1000 is improved to achieve a goal of timely communication. The implementation manner of transmission of specific operating parameters of the air conditioner 1000 is described below.

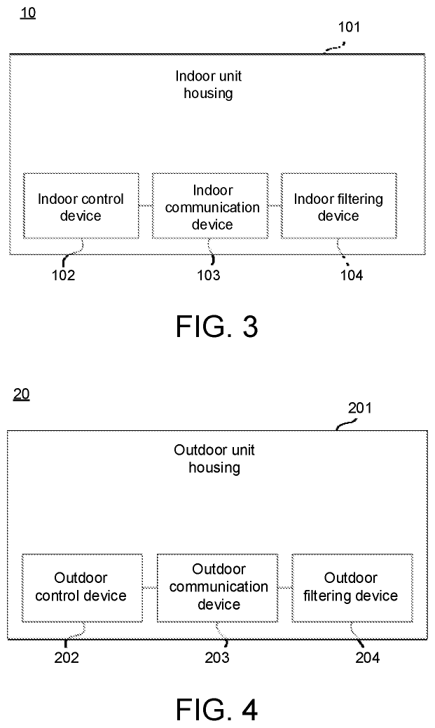

FIG. 3 is a block diagram of the indoor unit, in accordance with some embodiments. As shown in FIG. 3, the indoor unit 10 includes an indoor housing 101, an indoor control device 102, and an indoor communication device 103.

The indoor control device 102 is disposed inside the indoor housing 101. For example, the indoor control device 102 is an MCU, and the indoor control device 102 is configured to output indoor unit parameters. The indoor communication device 103 is coupled to the indoor control device 102, and the indoor communication device 103 is configured to receive the indoor unit parameters, and to generate a first high-frequency signal carrying the indoor unit parameters based on the received indoor unit parameters. The indoor communication device 103 loads the first high-frequency signal onto the power communication line. Therefore, the indoor unit parameters are output. In this way, the indoor unit parameters are output by using a manner of loading the first high-frequency signal onto the power communication line without changing the original communication line, thereby achieving the timely communication.

For example, the indoor communication device 103 includes an integrated circuit and a corresponding peripheral circuit. The integrated circuit includes at least one communication chip. The MCU of the indoor unit is coupled to the at least one communication chip, and the MCU outputs the indoor unit parameters to the at least one communication chip. The at least one communication chip generates a first high-frequency signal and loads the first high-frequency signal onto the power communication line, so as to output the indoor unit parameters. Therefore, it is possible to achieve a communication from an inside of the indoor unit 10 to an outside of the indoor unit 10.

In some embodiments, the power communication line is an AC power communication line used for indoor unit communication, such as a 24 VAC power communication line. However, a signal transmitted by the power communication line is not limited to a 24 VAC signal at power line frequency. As long as the devices withstand a voltage of the AC signal and the power signal can be filtered out, the AC signal may be set to any operating voltage range, such as 5 V, 12 V, or 20 V.

In some embodiments, as shown in FIG. 3, the indoor unit 10 further includes an indoor filtering device 104. The indoor filtering device 104 is coupled to the indoor communication device 103. The indoor filtering device 104 is configured to: receive a communication signal on the power communication line through a receiver of the indoor filtering device 104, filter out a power signal of the communication signal, and obtain a second high-frequency signal carrying transmitter parameters. The term “transmitter parameters” refers to parameters of a first transmitter. Here, the first transmitter may include a transmitter of the outdoor unit 20 or a transmitter of a temperature protector 30.

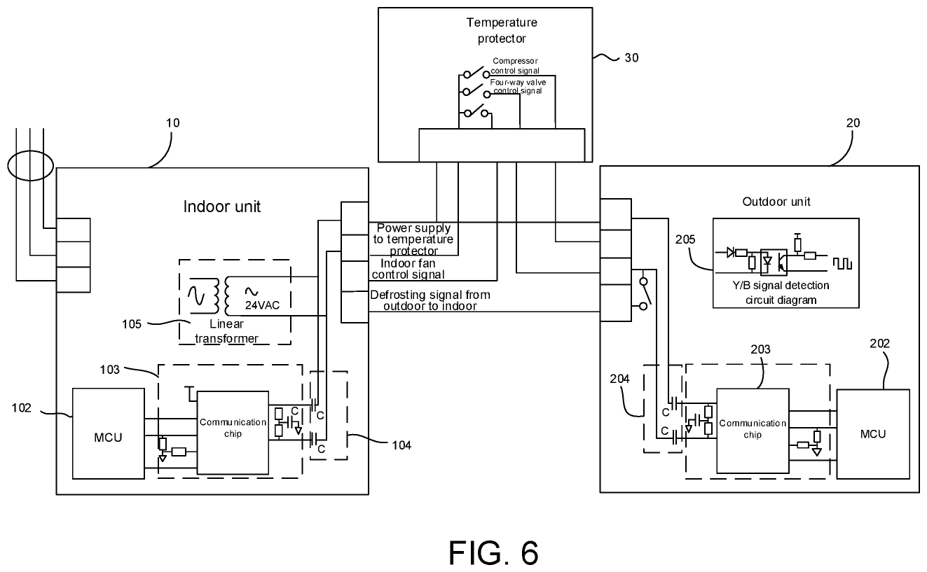

In some embodiments, the indoor filtering device 104 includes a capacitor C (see FIG. 6), and the capacitor C is configured to filter out the power signal of the communication signal. The indoor filtering device 104 is further configured to extract the transmitter parameters based on the second high-frequency signal, and to feed the transmitter parameters back to the indoor control device 102, so as to realize a communication from the outside of the indoor unit 10 to the inside of the indoor unit 10. Therefore, a two-way communication between a sending end and a receiving end is achieved; not only a high level portion and a low level portion in a square wave signal are recognized, but specific operating parameters of the sending end may be obtained in real time.

FIG. 4 is a block diagram of the outdoor unit, in accordance with some embodiments. As shown in FIGS. 3 and 4, the indoor unit 10 and the outdoor unit 20 each include a housing, a control device, and a communication device. The indoor control device 102 is configured to output the indoor unit parameters, and the indoor communication device 103 processes the indoor unit parameters to output the indoor unit parameters, thereby realizing the communication from the inside of the indoor unit 10 to the outside of the indoor unit 10. An outdoor control device 202 is configured to output outdoor unit parameters, and an outdoor communication device 203 processes the outdoor unit parameters to output the outdoor unit parameters, thereby realizing a communication from an inside of the outdoor unit 20 to an outside of the outdoor unit 20.

As shown in FIG. 4, the outdoor unit 20 includes an outdoor housing 201, the outdoor control device 202, and the outdoor communication device 203.

The outdoor control device 202 is disposed inside the outdoor housing 201. For example, the outdoor control device 202 is an MCU. The outdoor control device 202 is configured to output the outdoor unit parameters. The outdoor communication device 203 is coupled to the outdoor control device 202. The outdoor communication device 203 is configured to receive the outdoor unit parameters, generate a third high-frequency signal carrying the outdoor unit parameters based on the outdoor unit parameters, and load the third high-frequency signal onto the power communication line to output the indoor unit parameters. The outdoor communication device 203 includes an integrated circuit and a corresponding peripheral circuit. The integrated circuit includes at least one communication chip. The MCU of the outdoor unit 20 is coupled to the at least one communication chip. The MCU outputs the outdoor unit parameters to the at least one communication chip, and the at least one communication chip generates a third high-frequency signal and loads the third high-frequency signal onto the power communication line to output the outdoor unit parameters, so as to realize the communication from the inside of the outdoor unit 20 to the outside of the outdoor unit 20.

In some embodiments, the power communication line is an AC power communication line used for outdoor unit communication, such as a 24 VAC power communication line. However, a signal transmitted by the power communication line is not limited to a 24 VAC signal at power line frequency. As long as the devices withstand a voltage of the AC signal and the power signal can be filtered out, the AC signal may be set to any operating voltage range, such as 5 V, 12 V, or 20 V.

In some embodiments, as shown in FIG. 4, the outdoor unit 20 further includes an outdoor filtering device 204. The outdoor filtering device 204 is coupled to the outdoor communication device 203. The outdoor filtering device 204 is configured to: receive a communication signal on the power communication line through a receiver of the outdoor filtering device 204, filter out a power signal of the communication signal, and obtain a fourth high-frequency signal carrying transmitter parameters. The term “transmitter parameters” refers to parameters of a second transmitter. Here, the second transmitter may include a transmitter of the indoor unit 10 or the transmitter of the temperature protector 30. In some embodiments, the outdoor filtering device 204 includes a capacitor C (see FIG. 6), and the capacitor C filters a signal.

If the outdoor unit 20 is a variable frequency unit, the outdoor unit 20 may perform variable frequency operation only by detecting the outdoor unit parameters. If the outdoor unit 20 fails to receive some key parameters of the indoor unit 10, the outdoor unit 20 may not fully perform the variable frequency function; and in this case, although the outdoor unit 20 performs the variable frequency operation, the energy efficiency is low. The outdoor filtering device 204 provided in the embodiments of the present disclosure extracts the transmitter parameters based on the fourth high-frequency signal, and feeds the transmitter parameters back to the outdoor control device 202, so as to realize the communication from the outside of the outdoor unit 20 to the inside of the outdoor unit 20. For example, the outdoor unit 20 may not only perform the variable frequency operation by detecting the outdoor unit parameters, but also receive the indoor unit parameters. Therefore, the outdoor unit 20 may fully perform the variable frequency operation, thereby improving the energy efficiency.

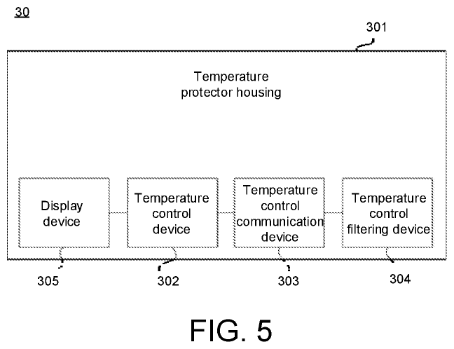

FIG. 5 is a block diagram of the temperature protector 30, in accordance with some embodiments. As shown in FIGS. 3 and 5, the indoor unit 10 and the temperature protector 30 each include a housing, a control device, and a communication device. The indoor control device 102 is configured to output the indoor unit parameters, and the indoor communication device 103 processes the indoor unit parameters, so as to output the indoor unit parameters, so as to realize the communication from the inside of the indoor unit 10 to the outside of the indoor unit 10. A temperature control device 302 outputs temperature control setting parameters. A temperature control communication device 303 receives the temperature control setting parameters output by the temperature control device 302, generates a fifth high-frequency signal, and loads the fifth high-frequency signal onto a power communication line, so as to output the temperature control setting parameters. As shown in FIG. 5, the temperature protector 30 includes a temperature protector housing 301, the temperature control device 302, and the temperature control communication device 303. The temperature control device 302 is disposed inside the temperature protector housing 301, and the temperature control device 302 of the temperature protector 30 may receive the temperature control setting parameters input by the user. The temperature control communication device 303 is coupled to the temperature control device 302 and is configured to receive the temperature control setting parameters output by the temperature control device 302. For example, the temperature control communication device 303 includes an integrated circuit and a corresponding peripheral circuit, and the integrated circuit includes at least one communication chip. The temperature control device 302 is an MCU, and the MCU is coupled to the at least one communication chip of the temperature control communication device 303. The MCU outputs the temperature control setting parameters to the at least one communication chip, and the at least one communication chip generates a fifth high-frequency signal and loads the fifth high-frequency signal onto the power communication line, so as to output the temperature control setting parameters.

In some embodiments, as shown in FIG. 5, the temperature protector 30 further includes a temperature control filtering device 304, and the temperature control filtering device 304 is coupled to the temperature control communication device 303. The temperature control filtering device 304 is configured to: receive a communication signal on the power communication line through a receiver of the temperature control filtering device 304, filter out a power signal of the communication signal, and obtain a sixth high-frequency signal carrying transmitter parameters. The term “transmitter parameters” refers to parameters of a third transmitter. Here, the third transmitter includes the transmitter of the indoor unit 10 or the transmitter of the outdoor unit 20. The temperature control filtering device 304 is further configured to extract the transmitter parameters based on the sixth high-frequency signal and feed the transmitter parameters back to the temperature control device 302, so as to realize a communication from an outside of the temperature protector 30 to an inside of the temperature protector 30.

The air conditioner 1000 provided in the embodiments of the present disclosure adopts a communication manner of loading a high-frequency signal on a power communication line instead of an AC strong electricity carrier communication manner. Therefore, there is no need to provide a circuit for the AC strong electricity carrier communication between any two of the indoor unit 10, the outdoor unit 20, and the temperature protector 30. In this way, it may be possible to simplify the circuit structure and save costs; and in addition, a real-time communication between any two of the indoor unit 10, the outdoor unit 20, and the temperature protector 30 is realized, and the energy efficiency of the air conditioner 1000 is improved.

In some embodiments, as shown in FIG. 5, the temperature protector 30 further includes a display device 305. The display device 305 is coupled to the temperature control device 302 and is configured to display received the parameters of the third transmitter. For example, the display device 305 is a display screen, a display light, or an alarm device disposed on the temperature protector housing 301.

When the outdoor unit 20 (or the indoor unit 10) has a failure, the outdoor unit 20 (or the indoor unit 10) outputs fault information parameters. The temperature protector 30 receives the fault information parameters and then extracts out transmitter fault information parameters from a received high-frequency signal including the fault information parameters. The display device 305 displays the transmitter fault information parameters, so as to timely notify the user.

FIG. 6 is a diagram illustrating a communication manner of the air conditioner, in accordance with some other embodiments.

As shown in FIG. 6, in a case where the air conditioner 1000 adopts the AC power communication manner, the indoor unit 10, the outdoor unit 20, and the temperature protector 30 are each provided with a communication device and a filtering device therein, and each of the indoor filtering device 104, the outdoor filtering device 204, and the temperature control filtering device 304 includes at least two capacitors C. The at least two capacitors C are configured to filter out a power signal of a communication signal. When a communication signal passes through capacitors of a receiving end, a power signal of the communication signal is filtered out, and only a high-frequency signal remains.

As shown in FIG. 6, the indoor unit 10 further includes a linear transformer 105, and the linear transformer 105 is configured to modulate a voltage of an AC transmitted in the power communication line into a power signal voltage. Considering a 24 VAC as an example, the indoor unit 10 supplies power to the temperature protector through the power communication line; the outdoor unit 20 outputs a defrosting signal to the indoor unit 10 through the power communication line; and the temperature protector 30 outputs a compressor control signal and a four-way valve control signal to the outdoor unit 20 the power communication line, and outputs an indoor fan control signal to the indoor unit 10 through the power communication line. The outdoor unit 20 further includes a signal detection circuit 205 (e.g., a Y/B signal detection circuit), and the signal detection circuit 205 is configured to convert the AC signal (e.g., a 24 VAC signal) transmitted in the power communication line into a square wave signal. Considering the communication process between the outdoor unit 20 and the indoor unit 10 as an example, the MCU of the outdoor control device 202 outputs the outdoor unit parameters to the at least one communication chip of the outdoor communication device 203, and the at least one communication chip generates the high-frequency signal based on the outdoor unit parameters and loads the high-frequency signal onto the power communication line. For example, the power communication line is a 24 V power communication line, and a communication signal transmitted in the power communication line includes a high-frequency signal and a power signal, and the communication signals are transmitted through the 24 V power communication line to the receiver of the indoor filtering device 104 of the indoor unit 10. The indoor filtering device 104 filters out the power signal of the communication signal, and the high-frequency signal remains; and the indoor filtering device 104 transmits the high-frequency signal to the at least one communication chip of the indoor communication device of the indoor unit. The at least one communication chip of the indoor communication device may generate outdoor unit parameters based on the received high-frequency signal and then transmit the outdoor unit parameters to the MCU of the indoor control device. Similarly, the communication manner of the air conditioner 1000 provided in the embodiments of the present disclosure may be used for the indoor unit 10 to output the indoor unit parameters to the outdoor unit 20. Therefore, it may be possible to receive and send signals at the same time and to realize two-way communication between the indoor unit 10 and the outdoor unit 20.

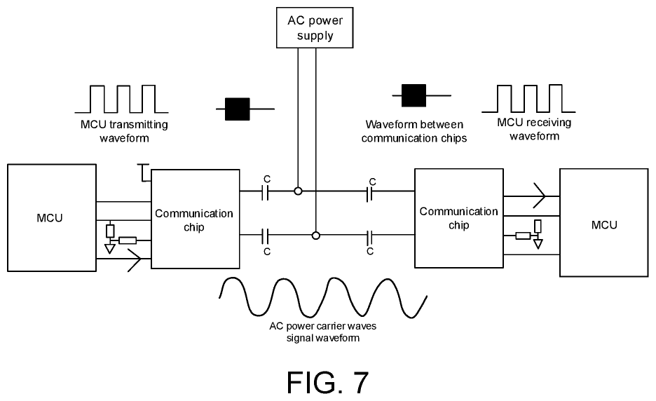

FIG. 7 is a diagram illustrating a communication waveform conversion of the air conditioner, in accordance with some embodiments.

In some embodiments, two-way communication between any two of the indoor unit, the outdoor unit, and the temperature protector may be realized by loading the high-frequency signal onto the AC power communication line. As shown in FIG. 7, an MCU outputs or recognizes only a high level portion and a low level portion in a square wave signal. The MCU outputs transmitter parameters to at least one communication chip in a form of a square wave signal. The at least one communication chip performs a frequency selection based on a grounding resistance coupled between the MCU and the at least one communication chip, generates a high-frequency signal based on the transmitter parameters, and then loads the high-frequency signal carrying the transmitter parameters onto a power communication line. The high-frequency signal carrying the transmitter parameters is transmitted to a receiver of a filtering device through the power communication line. After the receiver receives a communication signal, the filtering device filters out a power signal of the communication signal and obtains the high-frequency signal carrying the transmitter parameters. The at least one communication chip obtains the transmitter parameters based on the high-frequency signal, converts the transmitter parameters into a square wave signal, and outputs the square wave signal carrying the transmitter parameters to the MCU, so as to achieve transmission and recognition of signals. The power communication line is coupled to an AC power supply for AC power transmission. For example, the MCU of the indoor unit 10 outputs the indoor unit parameters to the at least one communication chip in the form of the square wave signal. The at least one communication chip of the indoor unit 10 performs the frequency selection based on the grounding resistance coupled between the MCU and the at least one communication chip, generates the high-frequency signal based on the indoor unit parameters, and then loads the high-frequency signal carrying the indoor unit parameters onto the power communication line. The high-frequency signal carrying the indoor unit parameters is transmitted to the receiver of the outdoor unit 20 through the power communication line. After the receiver of the outdoor unit 20 receives the high-frequency signal, the filtering device of the outdoor unit 20 filters out the power signal in the high-frequency signal and obtains the high-frequency signal carrying the indoor unit parameters. The at least one communication chip of the outdoor unit 20 obtains the indoor unit parameters based on the high-frequency signal, converts the indoor unit parameters into the square wave signal, and outputs the square wave signal carrying the indoor unit parameters to the MCU of the outdoor unit 20. As a result, the transmission and recognition of the signals is achieved.

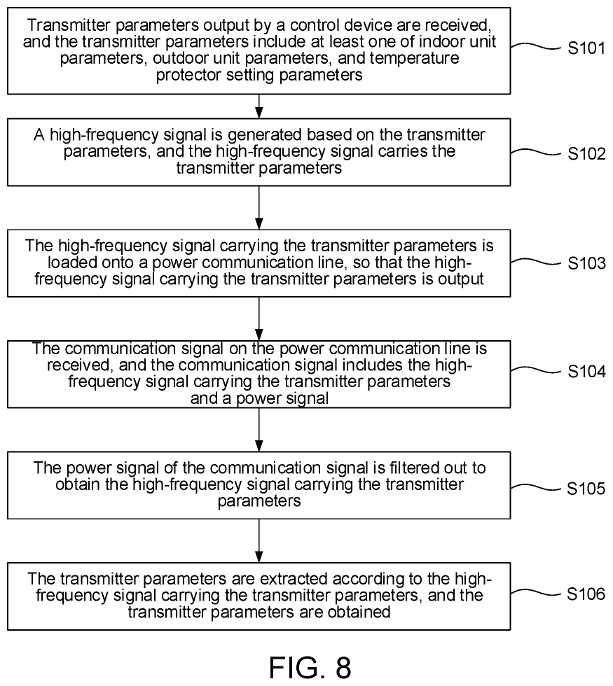

FIG. 8 is a flow diagram of a method for controlling communication of the air conditioner, in accordance with some embodiments.

As shown in FIG. 8, the method for controlling the communication of the air conditioner provided in the embodiments of the present disclosure includes steps S101 to S106.

In step S101, transmitter parameters output by a control device are received, and the transmitter parameters include at least one of indoor unit parameters, outdoor unit parameters, and temperature protector setting parameters.

For example, the control device is an indoor control device 102, an outdoor control device 202, or a temperature control device 302.

In step S102, a high-frequency signal is generated based on the transmitter parameters, and the high-frequency signal carries the transmitter parameters. For example, the communication device of the indoor unit, the communication device of the outdoor unit, or the communication device of the temperature protector receives the transmitter parameters and modulates the transmitter parameters to generate the high-frequency signal carrying the transmitter parameters.

In step S103, the high-frequency signal carrying the transmitter parameters is loaded onto a power communication line, so that the high-frequency signal carrying the transmitter parameters is output.

Compared to the AC strong electricity carrier communication manner, in the method for controlling the communication of the air conditioner provided in the embodiments of the present disclosure, the high-frequency signal is loaded onto the power communication line for transmission, so that the real-time communication between the indoor unit, the outdoor unit, and the temperature protector is realized, and there is no need to add a circuit for AC strong electricity carrier communication, thus saving costs.

In some embodiments of the present disclosure, a communication signal on the power communication line includes an AC power signal and a high-frequency signal carrying transmitter parameters. The manner to communicate through the AC power on the power communication line is adopted, and each of the indoor unit 10, the outdoor unit 20, and the temperature protector 30 may receive respective transmitter parameters in real-time, so as to realize real-time two-way communication. For example, when the indoor unit 10 or the outdoor unit 20 has a failure, the indoor unit 10 or the outdoor unit 20 outputs a high-frequency signal carrying fault information parameters. The temperature protector 30 receives the high frequency signal and then extracts out transmitter fault information parameters from the high frequency signal carrying the fault information parameters. The temperature protector 30 outputs the transmitter fault information parameters, and the display device 305 receives the transmitter fault information parameters and displays the transmitter fault information parameters, so that the user may be notified in real time.

In step S104, the communication signal on the power communication line is received, and the communication signal includes the high-frequency signal carrying the transmitter parameters and a power signal.

In some embodiments, the communication manner of the AC power on the power communication line is adopted, and the communication manner of loading the high-frequency signal on the power communication line is added. The communication signal on the power communication line includes the power signal and the high-frequency signal carrying the transmitter parameters. As a result, loading the high-frequency signal on the power communication line does not affect the transmission of the power signal between all components.

In step S105, the power signal of the communication signal is filtered out to obtain the high-frequency signal carrying the transmitter parameters. When the communication signal on the power communication line is received by a filtering device of the indoor unit, a filtering device of the outdoor unit, or a filtering device of the temperature protector, the filtering device filters out the power signal from the communication signal, and the high-frequency signal carrying the transmitter parameters remains.

In step S106, the transmitter parameters are extracted according to the high-frequency signal carrying the transmitter parameters, and the transmitter parameters are obtained. The communication device of the indoor unit, the communication device of the outdoor unit, or the communication device of the temperature protector includes a control device, and the control device is configured to extract the transmitter parameters from a high-frequency signal and obtain the transmitter parameters, thereby achieving the real-time communication between the indoor unit, the outdoor unit, and the temperature protector.

By using the method for controlling the communication of the air conditioner provided in the embodiments of the present disclosure, a sending end may output a power signal. Therefore, it may be possible to realize the opening and closing control of the outdoor unit and the indoor unit by the temperature protector or the AC power communication from the indoor unit to the outdoor unit through a one-way communication. In addition, the sending end may also output a high-frequency signal carrying transmitter parameters. The indoor unit, the outdoor unit, and the temperature protector each output transmitter parameters, so as to realize the real-time communication between the indoor unit, the outdoor unit, and the temperature protector. Furthermore, the high-frequency signal is loaded on the power communication line, the transmission of the two signals may not be affected, and there is no need to add the circuit for the AC power line carrier communication, thus simplifying the circuit structure and saving costs.

In a case where the outdoor unit is a variable frequency unit, the outdoor unit may not only perform variable frequency operation by detecting the outdoor unit parameters, but also receive parameters from the indoor unit and the temperature protector. Therefore, the variable frequency operation is fully performed, and the energy efficiency is improved.

A person skilled in the art will understand that, the scope of disclosure in the present disclosure is not limited to specific embodiments discussed above, and may modify and substitute some elements of the embodiments without departing from the spirits of this application. The scope of the application is limited by the appended claims.

What is claimed is:

1. An air conditioner, comprising:
an indoor unit including:
an indoor control device configured to output indoor unit parameters; and
an indoor communication device coupled to the indoor control device, wherein the indoor communication device is configured to: receive the indoor unit parameters, generate a first high-frequency signal carrying the indoor unit parameters based on the received indoor unit parameters, and load the first high-frequency signal onto a power communication line, so as to output the indoor unit parameters;
an outdoor unit coupled to the indoor unit through the power communication line, including:
an outdoor control device configured to output outdoor unit parameters; and
an outdoor communication device coupled to the outdoor control device, wherein the outdoor communication device is configured to: receive the outdoor unit parameters, generate a third high-frequency signal carrying the outdoor unit parameters based on the received outdoor unit parameters, and load the third high-frequency signal onto the power communication line, so as to output the outdoor unit parameters; and
a temperature protector coupled to the indoor unit and the outdoor unit through the power communication line, including:
a temperature control device configured to output temperature control setting parameters; and
a temperature control communication device coupled to the temperature control device, wherein the temperature control communication device is configured to: receive the temperature control setting parameters, generate a fifth high-frequency signal carrying the temperature control setting parameters based on the received temperature control setting parameters, and load the fifth high-frequency signal onto the power communication line, so as to output the temperature control setting parameters.

2. The air conditioner according to claim 1, wherein the indoor unit further includes:
an indoor filtering device coupled to the indoor communication device, wherein the indoor filtering device is configured to: receive a communication signal on the power communication line, filter out a power signal of the communication signal to obtain a second high-frequency signal carrying transmitter parameters; and
wherein the indoor filtering device is further configured to extract the transmitter parameters based on the second high-frequency signal and feed the transmitter parameters back to the indoor control device.

3. The air conditioner according to claim 1, wherein the indoor unit further includes:
a linear transformer configured to modulate a voltage of an alternating current transmitted in the power communication line into a power signal voltage.

4. The air conditioner according to claim 1, wherein the outdoor unit further includes:
an outdoor filtering device coupled to the outdoor communication device, wherein the outdoor filtering device is configured to receive a communication signal on the power communication line, filter out a power signal of the communication signal to obtain a second high-frequency signal carrying transmitter parameters; and
wherein the outdoor filtering device is further configured to extract the transmitter parameters based on the fourth high-frequency signal and feed the transmitter parameters back to the outdoor control device.

5. The air conditioner according to claim 4, wherein the outdoor filtering device includes at least one capacitor, and the at least one capacitor is configured to filter out the power signal of the communication signal.

6. The air conditioner according to claim 1, wherein the outdoor unit further includes:
a signal detection circuit configured to convert alternating current power signals transmitted in the power communication line into a first-level signal and a second-level signal.

7. The air conditioner according to claim 6, wherein the first-level signal and the second-level signal include signals for starting or stopping a compressor, opening a four-way valve, and a defrosting signal output from the outdoor unit to the indoor unit.

8. The air conditioner according to claim 1, wherein the temperature protector further includes:
a temperature control filtering device coupled to the temperature control communication device, wherein the temperature control filtering device is configured to receive a communication signal on the power communication line, filter out a power signal of the communication signal, and obtain a sixth high-frequency signal carrying transmitter parameters.

9. The air conditioner according to claim 8, wherein the temperature control filtering device is further configured to: extract the transmitter parameters according to the sixth high-frequency signal and feed the transmitter parameters back to the temperature control device.

10. The air conditioner according to claim 1, wherein the temperature protector further includes:
a display device coupled to the temperature control device, wherein the display device is configured to display transmitter parameters.

11. The air conditioner according to claim 1, wherein the indoor unit parameters include an ambient temperature and an indoor coil temperature.

12. The air conditioner according to claim 1, wherein the outdoor unit parameters include a compressor frequency and an outdoor coil temperature.

13. The air conditioner according to claim 1, wherein the power communication line is an alternating current power communication line.

14. The air conditioner according to claim 1, wherein the indoor control device is a microcontroller unit.

15. The air conditioner according to claim 14, wherein the indoor communication device includes at least one communication chip, the at least one communication chip is coupled to the microcontroller unit, and the at least one communication chip is configured to receive the indoor unit parameters and generate the first high frequency signal, and load the first high frequency signal onto the power communication line.

16. A temperature protector, comprising:
a temperature control device configured to output temperature control setting parameters; and
a temperature control communication device coupled to the temperature control device, wherein the temperature control communication device is configured to: receive the temperature control setting parameters, generate a fifth high-frequency signal carrying the temperature control setting parameters based on the received temperature control setting parameters, and load the fifth high-frequency signal onto the power communication line, so as to output the temperature control setting parameters.

17. The temperature protector according to claim 16, further comprising:
a temperature control filtering device coupled to the temperature control communication device, wherein the temperature control filtering device is configured to: receive a communication signal on the power communication line, filter out a power signal of the communication signal, and obtain a sixth high-frequency signal carrying transmitter parameters; and
wherein the temperature control filtering device is further configured to: extract the transmitter parameters based on the sixth high-frequency signal and feed the transmitter parameters back to the temperature control device.

18. The temperature protector according to claim 16, further comprising:
a display device coupled to the temperature control device, wherein the display device is configured to display the transmitter parameters.

19. A method for controlling communication of an air conditioner, comprising:
receiving transmitter parameters output from a control device, wherein the transmitter parameters include at least one of indoor unit parameters, outdoor unit parameters, or temperature protector setting parameters;
generating a high-frequency signal carrying the transmitter parameters based on the transmitter parameters; and
loading the high-frequency signal carrying the transmitter parameters onto a power communication line to output the transmitter parameters.

20. The method according to claim 19, further comprising:
receiving a communication signal on the power communication line, wherein the communication signal include the high-frequency signal carrying the transmitter parameters and a power signal;
filtering out the power signal of the communication signal to obtain the high-frequency signal carrying the transmitter parameters;
extracting the transmitter parameters from the high-frequency signal carrying the transmitter parameters; and
feeding the transmitter parameters back to the control device.
